(19) United States
(12) Patent Application Publication
(10) Pub. No.: US 2002/0022102 A1
(43) Pub. Date: Feb. 21, 2002

(54) Label and printing method for the label

(75) Inventors: Nobuyoshi Kiyohara, Tokyo (JP); Hidekazu Takahashi, Tokyo (JP); Mitsuyoshi Hosogai, Tokyo (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: HONDA GIKEN KOGYO KABUSHIKI KAISHA

(21) Appl. No.: 09/915,352

(22) Filed: Jul. 27, 2001

(30) Foreign Application Priority Data
Aug. 17, 2000 (JP) P2000-247511

(51) Int. Cl. B32B 7/06

(52) U.S. Cl. 428/40.1; 283/81

(57) ABSTRACT

Adhesive layers and strip layers are formed to alternate with one another on each of opposing surfaces of a pair of label base materials opposing each other. The pair of label base materials are superimposed onto each other such that each of the adhesive layers formed on one of the pair of label base materials overlaps corresponding one of the strip layers formed on the other one of the pair of label base materials. Thereby, strip paper sheets can be avoided; and in addition, the number of prints can be easily increased without increasing the printing speed

### TECHNICAL FIELD

The present invention relates to a label and a printing method for the label on which information regarding a product put in a bag or a box is printed and which is affixed onto the bag or the box for pigeonhole management, storage, display, or exhibition.

### BACKGROUND ART

Conventionally, as shown in FIGS. 9 and 10, the label L of this type has a constitution in which an adhesive is applied to the entire reverse surface of a label base material 1, thereby forming an adhesive layer 2; and in addition, a strip paper sheet 3 is pasted on the adhesive layer 2 in a manner to cover it. As shown in FIGS. 11 and 12, product information X (such as a manufacturer name, a product name, quantity, and a manufacturing date) is preprinted on the surface of the aforementioned label base material 1. When it is used, the strip paper sheet 3 is peeled away from the adhesive layer 2 to thereby expose the adhesive layer 2. The adhesive layer 2 works to affix the label base material 1 onto the surface of a bag 4 or a box 5.

Constitutions of labels similar to the above-described label are disclosed in, for example, Japanese Unexamined Patent Application Publications Nos. 8-269410 and 6-19398.

In each of these conventional labels, however, the strip paper sheet 3 must be used. This arises a problem in that the manufacturing cost of the label L is high. In addition, since the strip paper sheet 3 is discarded after it is used, the conventional labels are disadvantageous in view of resource-saving.

In addition, to increase the number of prints of the label L, the printing speed is increased. However, since the area where the production information is to be printed is a single face of the label base material 1, when the printing speed is increased as above-described, static electricity is likely to be generated due to friction and the like that are caused in transfer of the label L. The static electricity can cause a mechanical problem in a printer. In addition, the friction can cause a problem of wear in a label feed mechanism.

The present invention is made in view of the problems with the conventional cases. Accordingly, an object of the invention is to provide a label and printing method for the label for which the strip paper sheet need not be used and of which the number of prints can be increased without increasing the printing speed.

### DISCLOSURE OF INVENTION

A label of the present invention is characterized in that adhesive layers and strip layers are formed to alternate with one another on each of opposing surfaces of a pair of label base materials opposing each other, and the pair of label base materials are superimposed onto each other such that each of the adhesive layers formed on one of the pair of label base materials (one-side label base material) overlaps corresponding one of the strip layers formed on the other one of the pair of label base materials (other-side label base material).

According to the above constitution, the one-side label base material works as a strip paper sheet of the other-side label base material, and the other-side label base material works as a strip paper sheet of the one-side label base material.

In a state where the two label base materials are peeled away from each other, the label base materials can be independently affixed onto objects, such as bags or boxes, via the adhesive layers individually provided thereon.

The label of the present invention is also characterized in that the adhesive layers and strip layers are positioned to alternate with one another and to thereby form a checkered pattern on the pair of label base materials.

In the above constitution, each of the label base materials can be affixed on an object via a large number of the adhesive layers. Therefore, the label base materials can be securely affixed to the objects.

The label of the present invention is characterized in that an adhesive layers and strip layers are positioned to alternate one another and to thereby form a streaky pattern on said pair of label base materials.

In the above constitution, each of the label base materials can be affixed on an object via a large number of the adhesive layers. Therefore, the label base materials can be securely affixed to the objects.

The label of the present invention is characterized in that an auxiliary strip layer extending to a peripheral portion of each of said pair label base materials is formed in a portion of the adhesive layer formed at a corner portion of each of said pair of label base materials.

With the auxiliary peel-away layer formed as described above, peeling-away work for the two label base materials can be facilitated.

A printing method of the present invention is for performing printing on the label described above and is characterized in that on a transfer pass where the label in the state where the pair of label base materials are superimposed onto each other is transferred, print heads are disposed on two sides sandwiching the transfer pass to be apart at a distance from each other in a transfer direction along which the label is transferred, wherein the print head disposed on an upper-stream side of the transfer direction performs printing on a surface of the one-side label base material, and the print head disposed on a lower-stream side of the transfer direction subsequently performs printing on a surface of the other-side label base material.

According to the above arrangement, continuous printing can be performed on the label base materials. Thereby, printing processing can be improved without increasing the printing speed.

A printing method of the present invention is for performing printing on the label described above and is characterized in that on a transfer pass where the label in the state where the pair of label base materials are superimposed onto each other is transferred, a pair of print heads are disposed on two sides sandwiching the transfer pass to oppose each other, wherein both the print heads perform printing on surfaces of both the label base materials at the same time.

According to the above arrangement, the pair of label base materials can be printed at the same time. Thus, efficient printing processing can be performed.

### BRIEF DESCRIPTION OF THE DRAWINGS

FIG. 1 is a longitudinal cross-sectional view of a label according to an embodiment of the present invention;

FIG. 2 shows the label according to the embodiment of the present invention, in which (a) is a reverse-face view of one of label base materials thereof, and (b) is an enlarged view of portion A of (a);

FIG. 3 is a reverse-face view showing the other one of the label base materials for the label according to the embodiment of the present invention;

FIG. 4 is a longitudinal cross-sectional view of a label according to another embodiment of the present invention;

FIG. 5 is a reverse-face view of one of label base materials for the label according to the embodiment of the present invention;

FIG. 6 is a reverse-face view showing the other one of the label base materials for the label according to the embodiment of the present invention;

FIG. 7 is a schematic configuration view of a system for carrying out an embodiment of a printing method according to the present invention;

FIG. 8 is a schematic configuration view of a system for carrying out another embodiment of a printing method according to the present invention;

FIG. 9 is a plan view of a conventional label;

FIG. 10 is a side view of the conventional label;

FIG. 11 is an overall perspective view showing a use state of the conventional label; and

FIG. 12 is an overall perspective view showing another example of a use state of the conventional label.

### BEST MODE FOR CARRYING OUT THE INVENTION

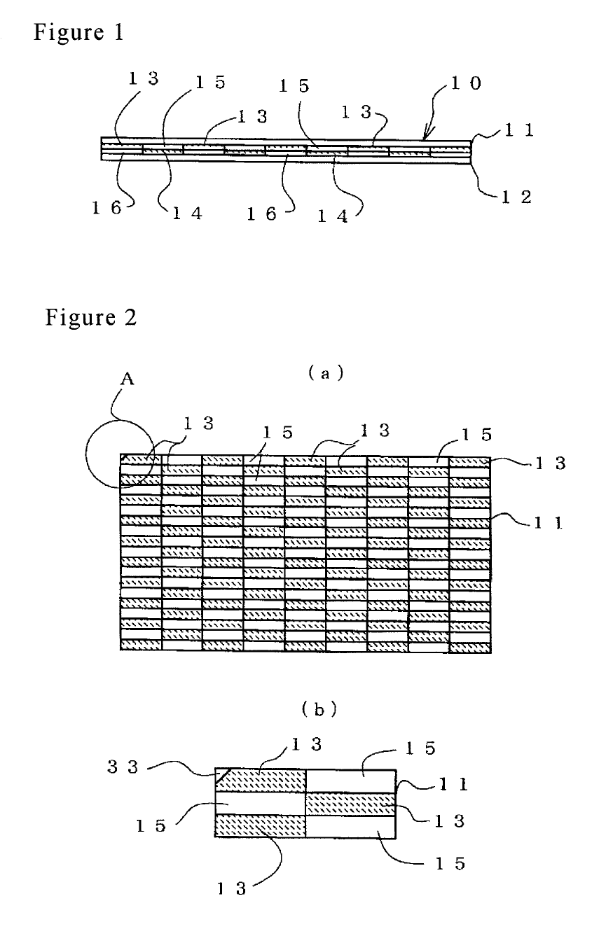

Referring to FIGS. 1 to 3, the present invention will be described in more detail.

In the figures, reference numeral 10 denotes a label according an embodiment. Basically, the label 10 is integrally constituted. Adhesive layers 13 and 14 and strip layers 15 and 16 are alternately formed on opposing surfaces of a pair of label base materials 11 and 12. The pair of label base materials 11 and 12 are oppositely superimposed onto each other such that each of the adhesive layers 13 formed on the label base material 11, which is one of the label base materials (which will be referred to as “one-side label base material”, hereinbelow), is overlapped with corresponding one of strip layers 15 formed on the other-side label base material 12, which is the other the label base material (which will be referred to as “other-side label base material”, hereinbelow).

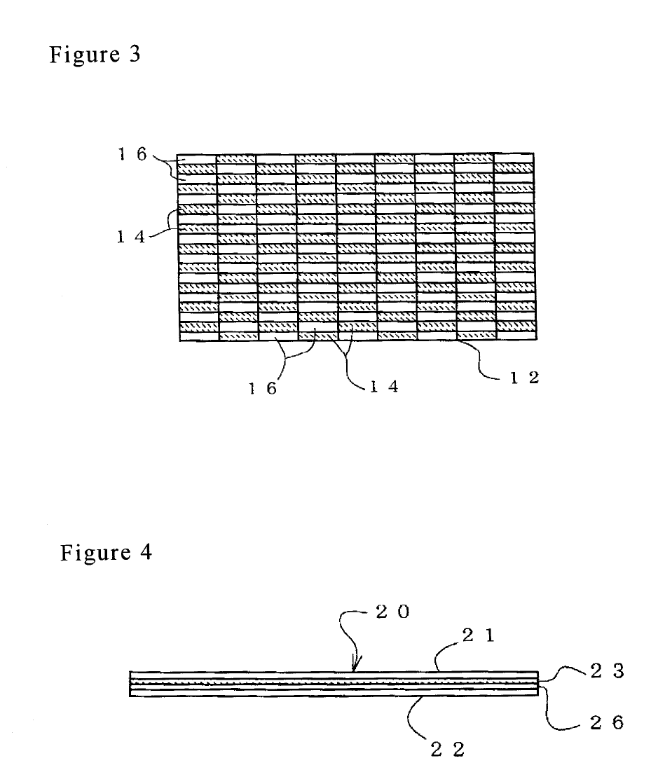

Hereinbelow, the above is described in detail. As shown in FIGS. 2 and 3, the adhesive layers 13 and 14 and the strip layers 15 and 16, which are formed on each of the label base materials 11 and 12, are alternately positioned in such a manner as to form a checkered pattern.

In a plan view, each of the adhesive layers 13 and 14 and each of the strip layers 15 and 16 are formed rectangular to have the identical size. The long-direction side thereof is set within a range of 10 mm to 30 mm, and the short-direction side thereof being is set within a range of 1.6 to 5 mm.

The label base materials 11 and 12 are superimposed onto each other such that reverse surfaces (the surfaces on which the adhesive layers 13 and 14 and the strip layers 15 and 16 are formed) of the label base materials 11 and 12 oppose each other. Each of the adhesive layers 13 formed on the one-side label base material 11 is overlapped with corresponding one of the strip layers 16 formed on the other-side label base material 12. Also, each of the adhesive layers 15 formed on the one-side label base material 11 is overlapped with corresponding one of the strip layers 14 formed on the other-side label base material 12. In this manner, the label 10 is produced.

In an unused state of the above-described label 10 according to the present embodiment, the one-side label base material 11 works as a strip layer of the other-side label base material 12. On the other hand, the other-side label base material 12 works as a strip layer of the one-side label base material 11.

Accordingly, no strip paper sheet needs to be provided.

In a use state of the label 10, by peeling the label base materials 11 and 12 to be away from each other, adhesive layers 13 and 14 and strip layers 15 and 16 of the respective label base materials 11 and 12 are exposed. Thereby, the label base material 11, 12 can be affixed to a bag or a box via the adhesive layer 13, 14.

In the label base material 11, 12 thus affixed thereto, the adhesive layers 13, 14 and the strip layers 15, 16 are formed to form a fine checkered pattern. That is, since the label base material 11, 12 is affixed via a large number of adhesive layers 13, 14, they are securely affixed.

In addition, in the label 10, the surfaces of each of the label base materials 11 and 12 are oppositely superimposed on each other is exposed so as to be independently printed. Therefore, compared to a case where printing is performed in units of one label, twofold issuance processing of the above-described label can be implemented.

Accordingly, without increasing the printing speed, the issuance number of the labels can be made twice. Therefore, the printing speed can be reduced to reduce the generation of static electricity, and concurrently, to delay the progress of wear. The above results in the reduction in occurrence of problems that can be caused by electrical problems caused in a printer and wear caused in the feed mechanism.

Hereinbelow, referring to FIGS. 4 to 6, a description will be given of a label according to another embodiment of the present invention.

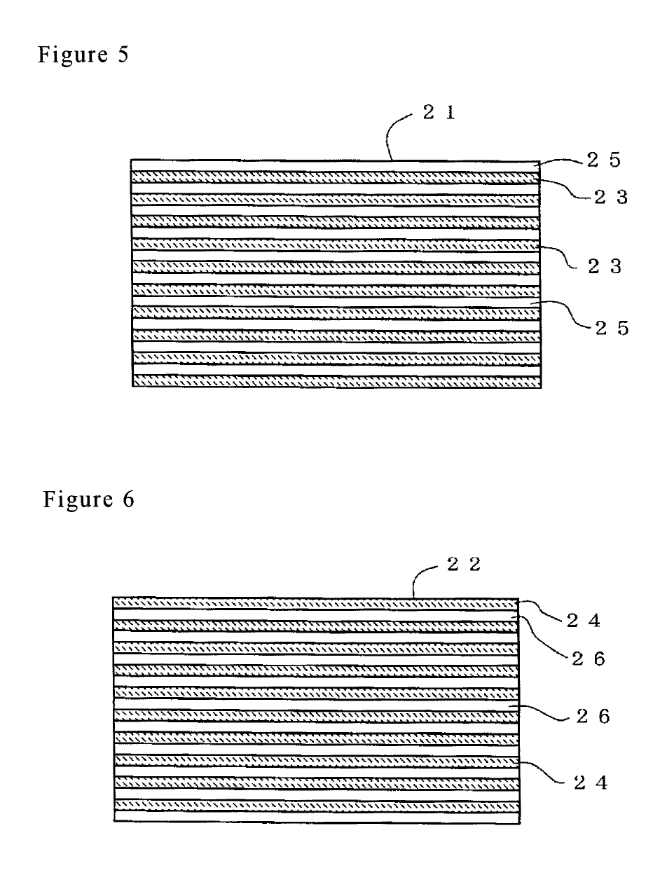

A label 20 of the present embodiment is characterized in that adhesive layers 23, 24 and strip layers 25, 26 are formed on a label base material 21, 22; and as shown in FIGS. 5 and 6, they are alternately disposed in such a manner as to form a streaky pattern thereon.

The label base material 21 and 22 are superimposed onto each other. In this, each of the adhesive layers 23 of the one-side label base material 21 is overlapped with corresponding on of the strip layer 26 of the other-side label base material 22. Also, each of the strip layers 25 of the one-side label base material 21 is overlapped with corresponding one of the adhesive layers 24 of the other-side label base material 22. In this manner, the label 20 of the present embodiment is produced.

Also in the present embodiment, effects similar to those in the embodiment first described can be obtained. In addition, in the present embodiment, since the adhesive layers 23 and 24 and the strip layers 25 and 26 are formed in the streaky pattern, the forming steps therefor can be simple.

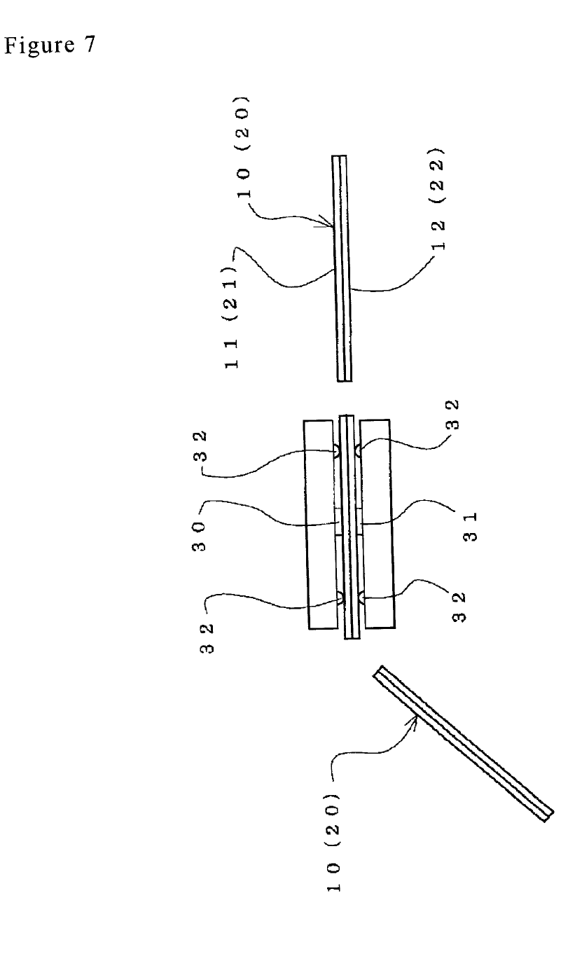

Hereinbelow, referring to FIG. 7, a description will be given of a printing method for printing information on the above-described label 10, 20.

On a transfer pass where the label 10 (20) in the state where the above-described pair of label base materials 11 and 12 (21 and 22) are superimposed onto each other is transferred, a pair of print heads 30 and 31 are disposed to oppose each other on two sides that sandwich the transfer pass. The label 10 (20) is fed between the print heads 30 and 31; and concurrently, both the print heads 30 and 31 operate at the same time. Thereby, printing is performed on the surfaces of the label base materials 11 and 12 (21 and 22) at the same time.

In FIG. 7, reference numeral 32 denotes each transfer roller that transfers the label 10 (20).

According to the printing method as described above, the two label base material 11 and 12 (21 and 22) are printed at the same time. Therefore, twofold printing is performed without increasing the printing speed.

The shapes and dimensions of the constitution members shown in the above-described embodiments are just examples. Therefore, they may be changed to meet design and the other requirements.

For example, particularly, in the embodiment shown in FIGS. 1 to 3, as illustrated in FIG. 2(b) in detail, an auxiliary strip layer 33 extending to a peripheral portion of the label base material 11 may be formed in a portion of the adhesive layer 13 formed at a corner portion of the label base material (which corresponds to the one-side label base material 11 in the illustrated example).

By forming the auxiliary strip layer 33, both the label base materials 11 and 12 can be easily peeled away from each other.

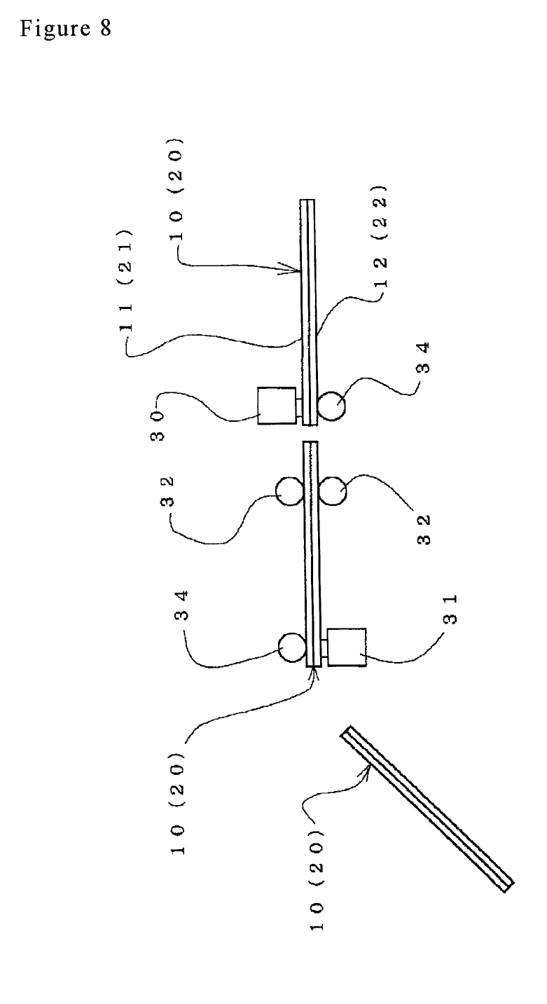

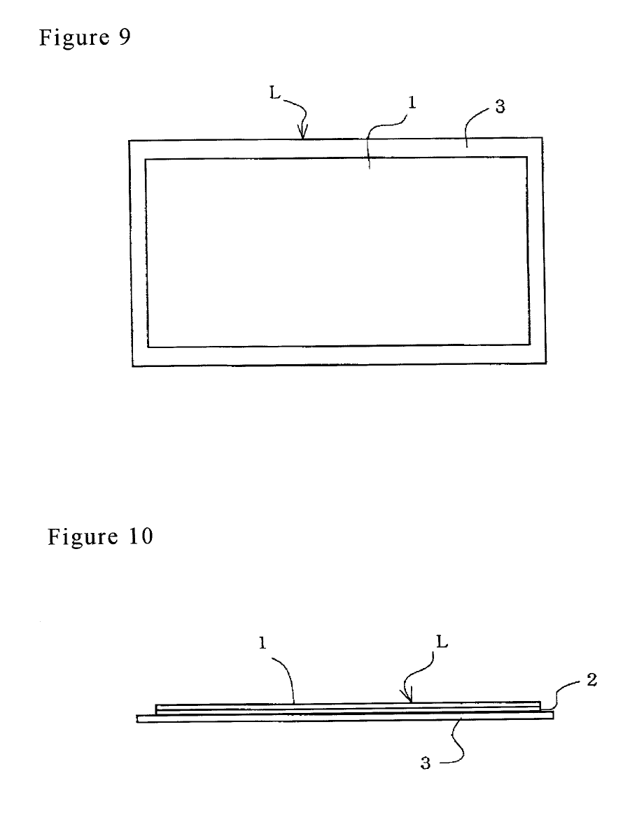

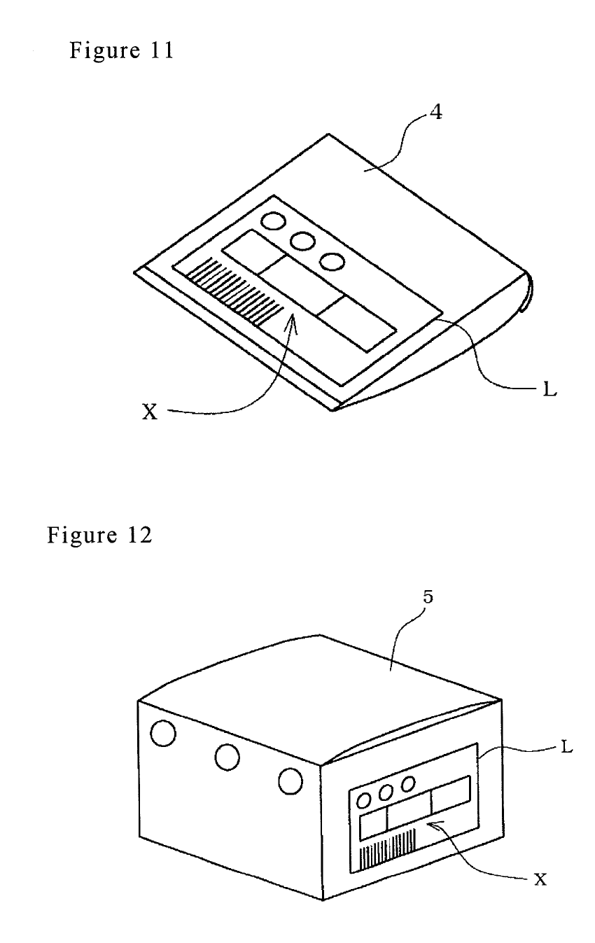

The method for performing printing on the label 10 (20) may also be modified. As shown in FIG. 8, on a transfer pass where the label 10 (20) in the state where the above-described pair of label base materials 11 and 12 (21 and 22) are superimposed onto each other is transferred, the pair of print heads 30 and 31 are disposed on two sides that sandwich the transfer pass. In this case, the print heads 30 and 31 are disposed away from each other in the direction along which the label 10 (20) is transferred. The print head 30 disposed on the upper-stream side of the transfer direction is controlled to perform printing on the surface of the one-side label base material 11 (21); and the print head 31 disposed on the lower-stream side of the transfer direction is controlled to subsequently perform printing on the surface of the other-side label base material 12 (22).

In FIG. 8, reference numeral 34 denotes each of platen rollers, each of which is disposed to oppose the print head 30, 31.

The above-described printing method also is capable of performing printing on the label base materials 11 and 12 (21 and 22) positioned, respectively, on the two surfaces of the label 10 (20).

Industrial Applicability

As described above, according to the present invention, the one-side label base material can be used to work as a strip paper sheet of the other-side, and the other-side label base material can be used to work as a strip paper sheet of the one-side label base material. Thereby, strip paper sheets conventionally required can be avoided.

Accordingly, constitution members of the label can be reduced to thereby allow the manufacturing cost thereof to be reduced, and in addition, to thereby allow wastes to be reduced.

In addition, in the label, the surfaces of the individual label base material superimposed onto each other can be exposed. As a result, printing can be independently performed on the individual surfaces. Therefore, compared to the case where printing is performed in units of one label, twofold issuance processing can be implemented.

Thus, without increasing the printing speed, the issuance number of the labels can be made twice. In addition, the printing speed can be reduced to thereby reduce the amount of static electricity that can be generated, and concurrently, to thereby delay the progress of wear in the printer or the like. As a result, problems that can be caused by electrical problems caused in a printer and wear caused in the feed mechanism can be reduced.

1. A label characterized in that adhesive layers and strip layers are formed to alternate with one another on each of opposing surfaces of a pair of label base materials opposing each other, and said pair of label base materials are superimposed onto each other such that each of the adhesive layers formed on one of said pair of label base materials overlaps corresponding one of the strip layers formed on the other one of said pair of label base materials.

2. A label as defined in claim 1, characterized in that the adhesive layers and strip layers are positioned to alternate with one another and to thereby form a checkered pattern on said pair of label base materials.

3. A label as defined in claim 1, characterized in that the adhesive layers and strip layers are positioned to alternate one another and to thereby form a streaky pattern on said pair of label base materials.

4. A label as defined in one of claims 1 to 3, characterized in that an auxiliary strip layer extending to a peripheral portion of each of said pair label base materials is formed in a portion of the adhesive layer formed at a corner portion of each of said pair of label base materials.

5. A printing method for performing printing on said label as defined in one of claims 1 to 4, characterized in that on a transfer pass where said label in the state where said pair of label base materials are superimposed onto each other is transferred, print heads are disposed on two sides sandwiching the transfer pass to be apart at a distance from each other in a transfer direction along which said label is transferred, wherein the print head disposed on an upper-stream side of the transfer direction performs printing on a surface of said one of said pair of label base material, and the print head disposed on a lower-stream side of the transfer direction subsequently performs printing on a surface of said other one of said pair of label base material.

6. A printing method for performing printing on said label as defined in one of claims 1 to 4, characterized in that on a transfer pass where said label in the state where said pair of label base materials are superimposed onto each other is transferred, a pair of print heads are disposed on two sides sandwiching the transfer pass to oppose each other, wherein said pair of print heads perform printing on surfaces of said pair of label base materials at the same time.
